(19) United States
(12) Patent Application Publication
(10) Pub. No.: US 2017/0243480 A1
(43) Pub. Date: Aug. 24, 2017

(54) Hazard Alert System

(71) Applicant: Ernest Ray, Knoxville, TN (US)

(72) Inventor: Ernest Ray, Knoxville, TN (US)

(21) Appl. No.: 15/049,194

(22) Filed: Feb. 22, 2016

(51) Int. Cl. G08G 1/0955; G08G 1/09

(52) U.S. Cl. CPC G08G 1/0955; G08G 1/09

(57) ABSTRACT

A hazard alert system includes a vehicle that has a back side. A sign is removably coupled to said vehicle when the vehicle is parked on the side of a roadway. Thus, the sign may alert oncoming traffic to the vehicle. The sign includes an arrow. The sign is oriented in a selected manner such that the arrow points toward a selected side of the vehicle.

### BACKGROUND OF THE DISCLOSURE

### Field of the Disclosure

The disclosure relates to alert devices and more particularly pertains to a new alert device for alerting oncoming traffic to a hazard.

### SUMMARY OF THE DISCLOSURE

An embodiment of the disclosure meets the needs presented above by generally comprising a vehicle that has a back side. A sign is removably coupled to said vehicle when the vehicle is parked on the side of a roadway. Thus, the sign may alert oncoming traffic to the vehicle. The sign includes an arrow. The sign is oriented in a selected manner such that the arrow points toward a selected side of the vehicle.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of a hazard alert system according to an embodiment of the disclosure.

FIG. 2 is a back view of an embodiment of the disclosure.

FIG. 3 is a bottom view of an embodiment of the disclosure.

FIG. 4 is a cross sectional view taken along line 4-4 of FIG. 1 of an embodiment of the disclosure.

FIG. 5 is a perspective in-use view of an embodiment of the disclosure.

### DESCRIPTION OF THE PREFERRED EMBODIMENT

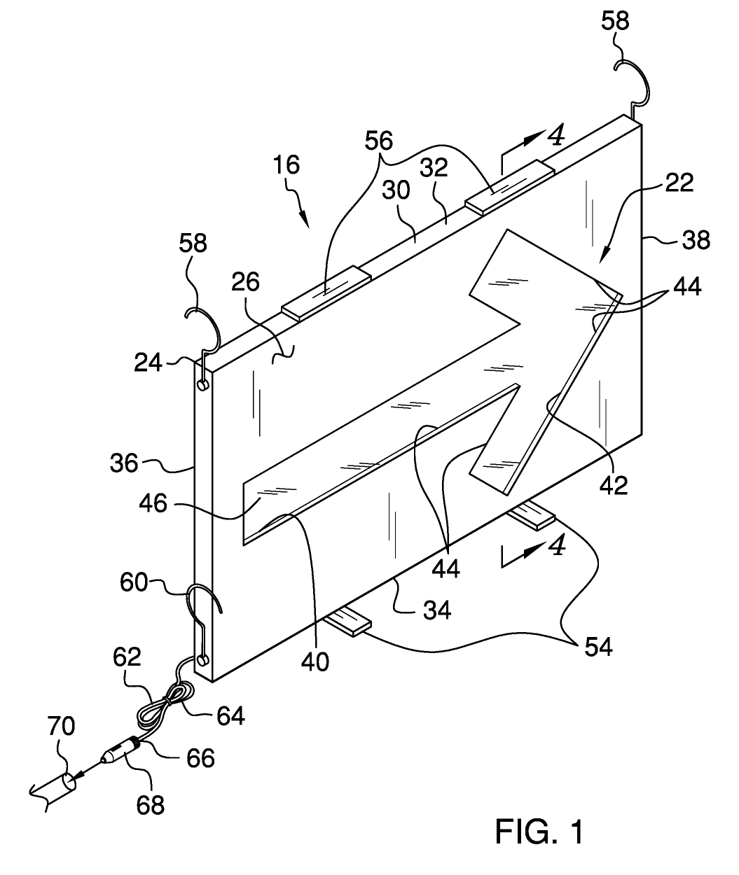

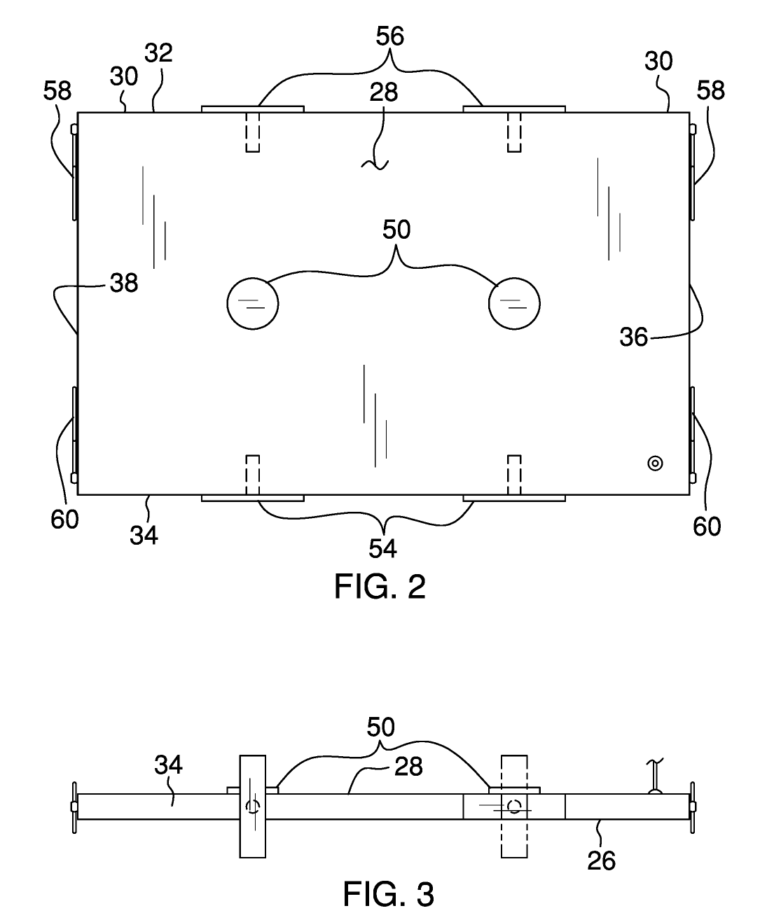

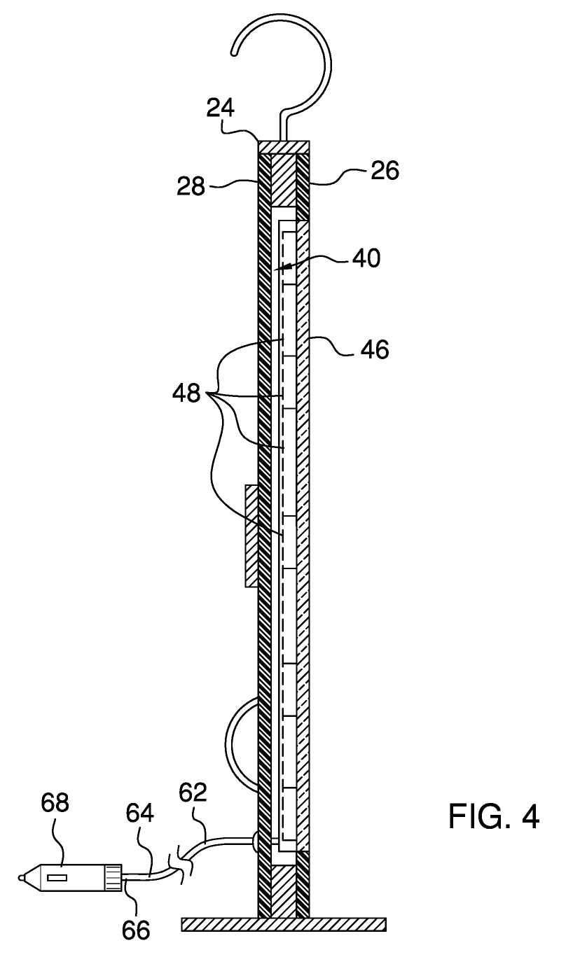

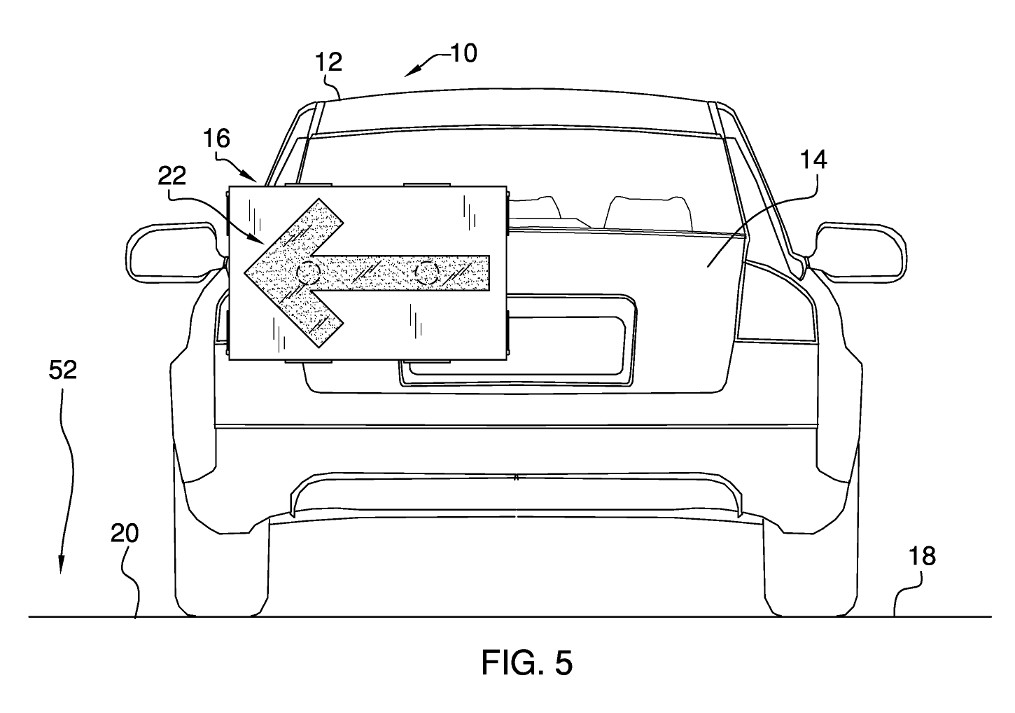

With reference now to the drawings, and in particular to FIGS. 1 through 5 thereof, a new alert device embodying the principles and concepts of an embodiment of the disclosure and generally designated by the reference numeral 10 will be described.

As best illustrated in FIGS. 1 through 5, the hazard alert system 10 generally comprises a vehicle 12 that has a back side 14. The vehicle 12 may comprise a passenger vehicle or the like. A sign 16 is provided and the sign 16 may be removably coupled to the vehicle 12 when the vehicle 12 is parked on the side 18 of a roadway 20. The vehicle 12 may be parked on the side 18 of the roadway 20 due to a mechanical problem or the like. Thus, the sign 16 may alerts oncoming traffic to the vehicle 12. The sign 16 includes an arrow 22. The sign 16 may be oriented in a selected manner such that the arrow 22 points toward a selected side of the vehicle 12.

The sign 16 comprises a panel 24 that has a front surface 26, a back surface 28 and a peripheral edge 30 extending between the front surface 26 and the back surface 28. The peripheral edge 30 has a top side 32, a bottom side 34, a first lateral side 36 and a second lateral side 38. The front surface 26 has an opening 40 extending therethrough and the opening 40 has a bounding edge 42. The bounding edge 42 has a plurality of intersecting sides 44 such that the opening 40 defines the arrow 22. The arrow 22 may point toward the second lateral side 38.

A window 46 is coupled to the panel 24. The window 46 is positioned within the opening 40 such that the window 46 completely covers the opening 40. The window 46 is comprised of a translucent material. A plurality of light emitters 48 is provided. Each of the light emitters 48 is coupled to the window 46 such that the light emitters 48 are positioned within the panel 24. Each of the light emitters 48 emits light outwardly from the window 46. Each of the light emitters 48 may comprise an LED or the like.

A pair of magnets 50 is provided and each of the magnets 50 is coupled to the back surface 28 of the panel 24. Each of the magnets 50 magnetically engages the back side 14 of the vehicle 12. Thus, the sign 16 is removably retained on the vehicle 12. The sign 16 is oriented to direct the arrow 22 in a selected direction. Thus, the arrow 22 may point toward a center 52 of the roadway 20 thereby facilitating oncoming traffic to be directed away from the vehicle 12.

A first pair of feet 54 is provided. Each of the first pair of feet 54 is rotatably coupled to the bottom side 34 of the panel 24. Each of the first pair of feet 54 is positionable in a deployed position having the first pair of feet 54 being oriented perpendicular to the front surface 26. Thus, the first pair of feet 54 may retain the panel 24 in an upright position on a support surface.

A second pair of feet 56 is provided. Each of the second pair of feet 56 is rotatably coupled to the top side 32 of the panel 24. Each of the second pair of feet 56 is positionable in a deployed position having the second pair of feet 56 being oriented perpendicular to the front surface 26. Thus, the second pair of feet 56 may retain the panel 24 in an upright position on the support surface.

A pair of first hooks 58 is provided. Each of the first hooks 58 is rotatably coupled to an associated one of the first lateral side 36 and the second lateral side 38. Each of the first hooks 58 is positionable in a deployed position. Thus, each of the first hooks 58 extends upwardly from the top side 32 and each of the first hooks 58 may suspend the panel 24 from a support.

A pair of second hooks 60 is provided. Each of the second hooks 60 is rotatably coupled to an associated one of the first lateral side 36 and the second lateral side 38. Each of the second hooks 60 is positionable in a deployed position. Thus, each of the second hooks 60 extends downwardly away from the bottom side 34 and each of the second hooks 60 may suspend the panel 24 from a support.

A power supply 62 is coupled to the panel 24 and the power supply 62 is electrically coupled to each of the light emitters 48. The power supply 62 comprises a cord 64 extending outwardly from the panel 24. The cord 64 has distal end 66 with respect to the panel 24 and a plug 68 is electrically coupled to the distal end 66. The plug 68 comprises a cigarette lighter adapter. Thus, the plug 68 may be electrically coupled to a cigarette lighter 70 in the vehicle 12. The cord 64 may have a length ranging between approximately two meters and three meters.

In use, the panel 24 is manipulated such that each of the magnets 50 magnetically engages the back side 14 of the vehicle 12 when the vehicle 12 is parked on the side 18 of the roadway 20. The panel 24 is oriented such that the arrow 22 points toward the center 52 of the roadway 20. The plug 68 is electrically coupled to the cigarette lighter 70 and the light emitters 48 are turned on. The panel 24 may be positioned on a support surface. The panel 24 may be positioned on the first set of feet 54 and the second set of feet 56 thereby facilitating the arrow 22 to point in a selected direction. Additionally, the panel 24 may be suspended with the first hooks 58 and the second hooks 60.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A hazard alert system comprising:
a vehicle having a back side;
a sign being removably coupled to said vehicle when said vehicle is parked on the side of a roadway wherein said sign is configured to alert oncoming traffic to the vehicle, said sign including a single arrow, said sign being oriented in a selected manner such that said single arrow points toward a selected side of said vehicle, said sign comprising a panel having a front surface, a back surface and a peripheral edge extending between said front surface and said back surface, said peripheral edge having a top side, a bottom side, a first lateral side and a second lateral side, said front surface having an opening extending therethrough, said opening having a bounding edge, said bounding edge having a plurality of intersecting sides such that said opening defines said single arrow pointing toward said second lateral side;
a pair of first hooks, each of said first hooks being rotatably coupled to an associated one of said first lateral side and said second lateral side, each of said first hooks being positionable in a deployed position having each of said first hooks extending upwardly from said top side wherein each of said hooks is configured to suspend said panel from a support; and
a pair of second hooks, each of said second hooks being rotatably coupled to an associated one of said first lateral side and said second lateral side, each of said second hooks being positionable in a deployed position having each of said second hooks extending downwardly away from said bottom side wherein each of said second hooks is configured to suspend said panel from a support.

2. (canceled)

3. The assembly according to claim 1, further comprising:
a window being coupled to said panel, said window being positioned within said opening such that said window completely covers said opening; and
a plurality of light emitters, each of said light emitters being coupled to said window such that said light emitters are positioned within said panel wherein each of said light emitters is configured to emit light outwardly from said window.

4. The assembly according to claim 1, further comprising a pair of magnets, each of said magnets being coupled to said back surface of said panel, each of said magnets magnetically engaging said back side of said vehicle such that said panel is removably retained on said vehicle, said panel being oriented to direct said single arrow in a selected direction wherein said single arrow is configured to point toward a center of the roadway thereby facilitating oncoming traffic to be directed away from said vehicle.

5. The assembly according to claim 1, further comprising:
a first pair of feet, each foot of said first pair of feet being rotatably coupled to said bottom side of said panel, each foot of said first pair of feet being positionable in a deployed position having said first pair of feet being oriented perpendicular to said front surface wherein said first pair of feet is configured to retain said panel in an upright position on a support surface; and
a second pair of feet, each foot of said second pair of feet being rotatably coupled to said top side of said panel, each foot of said second pair of feet being positionable in a deployed position having said second pair of feet being oriented perpendicular to said front surface wherein said second pair of feet is configured to retain said panel in an upright position on the support surface.

6. (canceled)

7. The assembly according to claim 3, further comprising a power supply being coupled to said panel, said power supply being electrically coupled to each of said light emitters, said power supply comprising a cord extending outwardly from said panel, said cord having distal end with respect to said panel, said distal end having a plug being electrically coupled thereto, said plug comprising a cigarette lighter adapter, said plug being electrically coupled to a cigarette lighter in said vehicle.

8. A hazard alert system comprising:
a vehicle having a back side; and
a sign being removably coupled to said vehicle when said vehicle is parked on the side of a roadway wherein said sign is configured to alert oncoming traffic to the vehicle, said sign including a single arrow, said sign being oriented in a selected manner such that said single arrow points toward a selected side of said vehicle, said sign comprising:
a panel having a front surface, a back surface and a peripheral edge extending between said front surface and said back surface, said peripheral edge having a top side, a bottom side, a first lateral side and a second lateral side, said front surface having an opening extending therethrough, said opening having a bounding edge, said bounding edge having a plurality of intersecting sides such that said opening defines said single arrow pointing toward said second lateral side,
a window being coupled to said panel, said window being positioned within said opening such that said window completely covers said opening,
a plurality of light emitters, each of said light emitters being coupled to said window such that said light emitters are positioned within said panel wherein each of said light emitters is configured to emit light outwardly from said window,
a pair of magnets, each of said magnets being coupled to said back surface of said panel, each of said magnets magnetically engaging said back side of said vehicle such that said panel is removably retained on said vehicle, said panel being oriented to direct said single arrow in a selected direction wherein said single arrow is configured to point toward a center of the roadway thereby facilitating oncoming traffic to be directed away from said vehicle,
a first pair of feet, each foot of said first pair of feet being rotatably coupled to said bottom side of said panel, each foot of said first pair of feet being positionable in a deployed position having said first pair of feet being oriented perpendicular to said front surface wherein said first pair of feet is configured to retain said panel in an upright position on a support surface,
a second pair of feet, each foot of said second pair of feet being rotatably coupled to said top side of said panel, each foot of said second pair of feet being positionable in a deployed position having said second pair of feet being oriented perpendicular to said front surface wherein said second pair of feet is configured to retain said panel in an upright position on the support surface,
a pair of first hooks, each of said first hooks being rotatably coupled to an associated one of said first lateral side and said second lateral side, each of said first hooks being positionable in a deployed position having each of said first hooks extending upwardly from said top side wherein each of said hooks is configured to suspend said panel from a support,
a pair of second hooks, each of said second hooks being rotatably coupled to an associated one of said first lateral side and said second lateral side, each of said second hooks being positionable in a deployed position having each of said second hooks extending downwardly away from said bottom side wherein each of said second hooks is configured to suspend said panel from a support, and
a power supply being coupled to said panel, said power supply being electrically coupled to each of said light emitters, said power supply comprising a cord extending outwardly from said panel, said cord having distal end with respect to said panel, said distal end having a plug being electrically coupled thereto, said plug comprising a cigarette lighter adapter, said plug being electrically coupled to a cigarette lighter in said vehicle.
